(19) United States
(12) Patent Application Publication
(10) Pub. No.: US 2010/0100901 A1
(43) Pub. Date: Apr. 22, 2010

(54) PLAYER DEVICE

(76) Inventors: Chih-Chieh Wu, Hsin Chu (TW); Chih-Ling Chang, Hsin Chu (TW)

Correspondence Address: Muncy, Geissler, Olds & Lowe, PLLC, P.O. BOX 1364, FAIRFAX, VA, 22038-1364, US

(21) Appl. No.: 12/418,399

(22) Filed: Apr. 3, 2009

(30) Foreign Application Priority Data
Oct. 17, 2008 (TW) 097218618

(51) Int. Cl. H04N 7/025; H04N 7/173

(52) U.S. Cl. 725/34; 725/110

(57) ABSTRACT

A player device including a processing module and a player module is provided. The player device is adapted for playing an internet broadcasting station or an internet TV station. The player device is connected to at least one server. A user can use the player module of the player device to select and download a station list. The player device is then connected to the selected internet broadcasting station or internet TV station. The player module directly plays a program of the connected internet broadcasting station or internet TV station. The player module may, together with the processing module, record the program of the connected internet broadcasting station or internet TV station or execute a program subscription setting. The player module can also receive advertising information transmitted from the advertisement broadcasting server in accordance with a region where the user is located or an ID code of the player device.

### BACKGROUND OF THE INVENTION

1. Field of the Invention

The present invention relates generally to a player device, and more particularly, to a player device for playing an internet broadcasting station and/or an internet TV station. When operating such a player device, the user selects and downloads a station list provided by an internet broadcasting station server or an internet TV station server. Then, a network connection is constructed between the player device and the selected internet radio station or internet TV station. Therefore, the player device can directly play a program of the internet broadcasting station or the internet TV station. The player device can further record the program of the internet broadcasting station or the internet TV station, and/or execute a program subscription setting. Even further, the player device can receive specified advertising information transmitted from an advertisement broadcasting server in accordance with an ID code of the player device or the region where the user is located.

2. The Prior Arts

Nowadays, when a user intends to play an internet broadcasting station or an internet TV station, the user usually has to search for a station list via certain websites, e.g., a website provided by Microsoft®. However, the user is often incapable of accessing the latest updated and most accurate station list of internet broadcasting stations and/or internet TV stations, and the website cannot provide a station list listing all internet broadcasting stations and/or internet TV stations.

Accordingly, an internet broadcasting station server or an internet TV station server is often used for providing the latest updated, most accurate, and overall station list of internet broadcasting stations and/or internet TV stations. However, a simpler approach is very much desired by the users for accessing the station list provided by the internet broadcasting station server or internet TV station server, for constructing a network connection thereto. Further, currently, the user is only allowed to directly play a program of the internet broadcasting stations and the internet TV stations, and is not allowed to record the program or execute a program subscription setting. Furthermore, the user cannot be provided with the advertising information provided in accordance with the region where the user is located or the player device used by the user, and thus cannot appreciate the convenience associated by the advertising information.

As such, a more capable player device is desired. A user can use such a player device to construct a connection to a selected internet broadcasting station or an internet TV station. The player device can be used to directly playing a program of the selected internet broadcasting station and the selected internet TV station, and can also be used to record the program or execute a program subscription setting. The player device can also receive specified advertising information transmitted from an advertisement broadcasting server in accordance with an equipment ID of the player device or the region where the user is located, so as to provide the convenience associated by the advertising information to the user.

### SUMMARY OF THE INVENTION

A primary objective of the present invention is to provide a player device. The player device is adapted for playing an internet broadcasting station or an internet TV station. The user can use this player device to select and download a station list provided by an internet broadcasting station server or an internet TV station server. A connection is then constructed between the player device and the selected internet broadcasting station or internet TV station. Then, the player device can directly playing a program of the internet broadcasting station or the internet TV station, and/or record the program or execute a program subscription setting.

Another objective of the present invention is to provide a player device. The player device is adapted for playing an internet broadcasting station or an internet TV station. The user can use this player device to receive advertising information transmitted by an advertisement broadcasting server in accordance with the region where the user is located or an ID code of the player device.

For achieving the foregoing objectives and others, the present invention provides a player device at least including a processing module, and a player module.

The player device of the present invention is connected to at least one server to configure a network connection. For example, the server can be at least one broadcasting station server, at least one internet TV station server, or at least one advertisement broadcasting server, or a combination thereof. The processing module of the player device can automatically or manfully execute a logging program so as to allow the server to identify and affirm the identification of the user, and access the setting made by the user. Then the user can use the player module of the player device to select and download a station list provided by an internet broadcasting server or an internet TV station server. The player device is then connected to at least one of the selected internet broadcasting stations and/or internet TV stations. The player module directly plays a program of the connected internet broadcasting station or internet TV station. The player module may further, together with the processing module, record the program of the connected internet broadcasting station or internet TV station or execute a program subscription setting. Furthermore, the player module can also receive advertising information transmitted from the advertisement broadcasting server in accordance with a region where the user is located or an ID code of the player device.

According to an aspect of the present invention, the player device is directly connected with an internet broadcasting server and/or an internet TV station, and/or an advertisement broadcasting server to configure a network connection. Alternatively, according to another aspect of the present invention, the player device is connected with an internet broadcasting server and/or an internet TV station, and/or an advertisement broadcasting server via a PC to configure a network connection.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram illustrating the architecture of a player device of the present invention;

FIG. 2 is a schematic diagram illustrating a player device according to an embodiment of the present invention; and

FIG. 3 is a schematic diagram illustrating a player device according to another embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

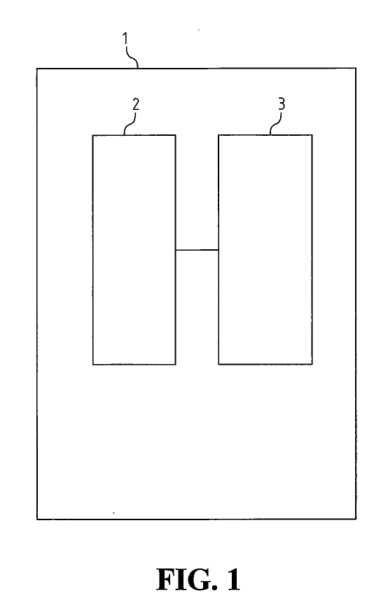

FIG. 1 is a schematic diagram illustrating the architecture of a player device of the present invention. Referring to FIG. 1, it shows a player device 1 of the present invention. The player device 1 includes a processing module 2, and a player module 3.

The player device 1 is directly connected to a server (not shown in the drawings), or connected to the server via a PC (not shown in the drawings) thus configuring a network connection. The server for example can be at least one internet broadcasting server (not shown in the drawings), and/or at least one internet TV station (not shown in the drawings), and/or at least one advertisement broadcasting server (not shown in the drawings). The processing module 2 of the player device 1 is adapted for automatically or manfully executing a logging program (not shown in the drawings). The logging program for example is provided by the server, or is a built-in program of the player device 1. The user then utilizes the logging program to transmit related information, e.g., user ID, to the server, for allowing the server to identify or confirm the user ID and access setting made by the user.

The user then uses the player module 3 of the player device 1 to select and download a station list (not shown in the drawings) provided by the internet broadcasting server or the internet TV station server. The player device 1 is then connected with at least one selected internet broadcasting station and/or at least one internet TV station for executing subsequent operation. For example, the player module 3 directly plays a program of the internet broadcasting station or the internet TV station. The player module 3 can also, together with the processing module 2, record the program and/or execute a program subscription setting. Further, the player module 3 can also receive advertising information transmitted from the advertisement broadcasting server in accordance with the region where the user is located or an ID code of the player device.

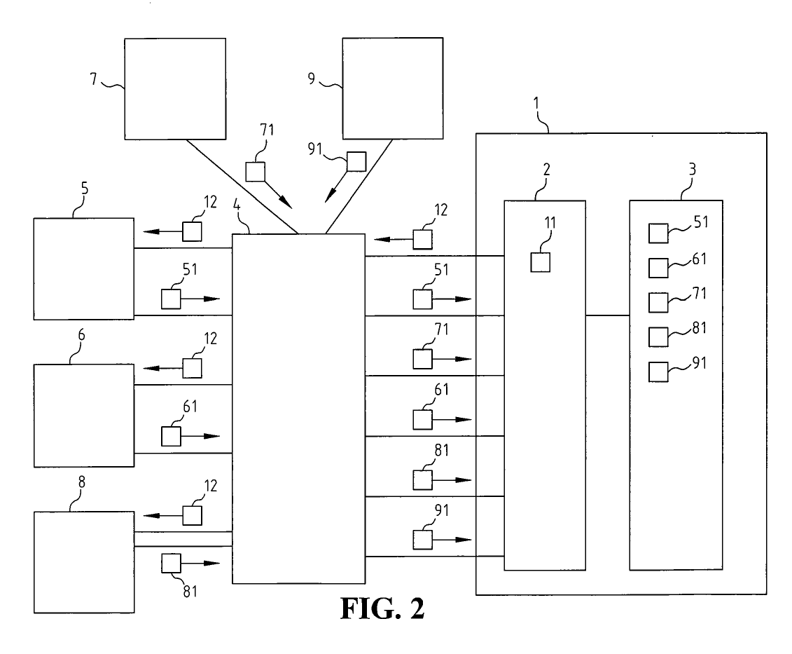

FIG. 2 is a schematic diagram illustrating a player device according to an embodiment of the present invention. Referring to FIG. 2, the player device 1 is connected to a PC 4, and is further connected to at least one internet broadcasting server 5, and/or at least one internet TV station server 8, and/or at least one advertisement broadcasting server 6 via the PC 4 to configure a network connection therebetween. The player device 1 includes the processing module 2 and the player module 3.

The player device 1 is wirely or wirelessly connected to at least one internet broadcasting server 5, and/or at least one internet TV station server 8, and/or at least one advertisement broadcasting server 6 via the PC 4 to configure a network connection. The processing module 2 of the player device 1 is adapted for automatically or manfully executing a logging program 11. The logging program 11 for example can be provided by the PC 4, the internet broadcasting station server 5, the internet TV station server 8, or the advertisement broadcasting server 6. Or alternatively, the logging program 1 may be a built-in program of the player device 1. The user then utilizes the logging program 11 to transmit related information 12, e.g., user ID, to the internet broadcasting station server 5, the internet TV station server 8, or the advertisement broadcasting server 6, for allowing the internet broadcasting station server 5, the internet TV station server 8, or the advertisement broadcasting server 6 to identify or confirm the user ID and access setting made by the user.

The user then uses the player module 3 of the player device 1 to select and download a broadcasting station list 51 provided by the internet broadcasting server 5 and/or a TV station list 81 provided by the internet TV station server 8. The player device 1 is then connected with at least one selected internet broadcasting station 7 and/or at least one internet TV station 9 for executing subsequent operation. For example, the player module 3 directly plays broadcasting a program 71 of the internet broadcasting station 7 or TV a program 91 of the internet TV station 9. The player module 3 can also, together with the processing module 2, record the broadcasting a program 71 and/or execute a program subscription setting of the internet broadcasting station 7 or the TV a program 91 of the internet TV station 9. Further, the player module 3 can also receive advertising information 61 transmitted from the advertisement broadcasting server 6 in accordance with the region where the user is located or an ID code of the player device 1.

The player device 1 for example can be a portable apparatus, such as an external hard drive, a pen drive, a multimedia player, an MP3. The processing module 2 is a hardware unit, such as a micro-controller unit (MCU), a central processing unit (CPU), a firmware, or a software. The player module 3 can be a hardware unit, a firmware, or a software.

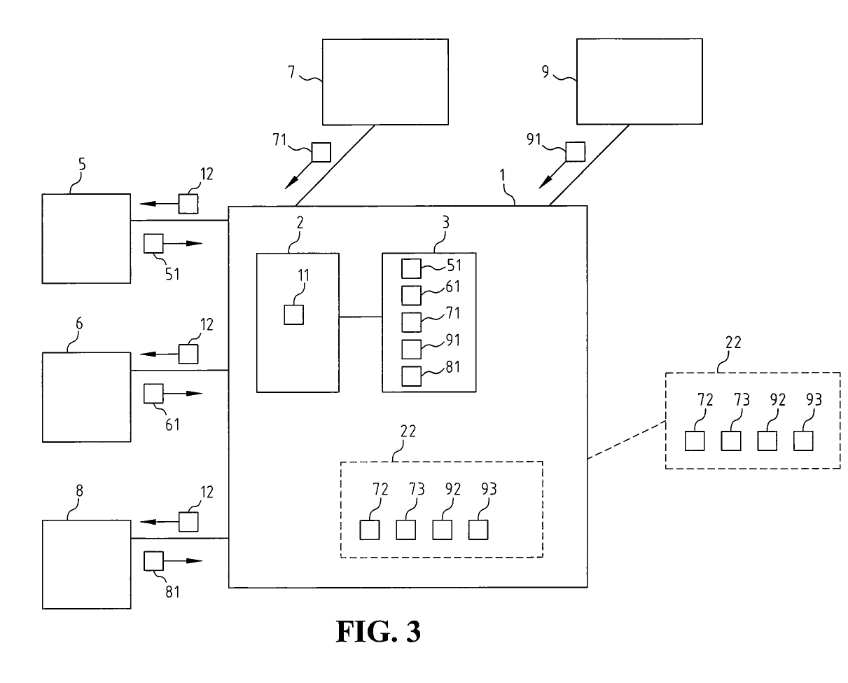

FIG. 3 is a schematic diagram illustrating a player device according to another embodiment of the present invention. Referring to FIG. 3, the player device I is directly connected to an internet broadcasting server 5 and/or at least one internet TV station server 8 and/or at least one advertisement broadcasting server 6. The player device 1 includes at least a processing module 2, and a player module 3.

The player device 1 is directly and wirely or wirelessly connected to at least one internet broadcasting server 5, and/or at least one internet TV station server 8, and/or at least one advertisement broadcasting server 6 to configure a network connection. The processing module 2 of the player device 1 automatically or manfully executes a logging program 11. The logging program 11 for example can be provided by the internet broadcasting station server 5, the internet TV station server 8, or the advertisement broadcasting server 6. Or alternatively, the logging program 11 can be a built-in program of the player device 1. The user then utilizes the logging program 11 to transmit related information 12, e.g., user ID, to the internet broadcasting station server 5, the internet TV station server 8, or the advertisement broadcasting server 6, for allowing the internet broadcasting station server 5, the internet TV station server 8, or the advertisement broadcasting server 6 to identify or confirm the user ID and access setting made by the user.

The user then uses the player module 3 of the player device 1 to select and download a broadcasting station list 51 provided by the internet broadcasting server 5 and/or a TV station list 81 provided by the internet TV station server 8. The player device 1 is then connected with at least one selected internet broadcasting station 7 and/or at least one internet TV station 9 for executing subsequent operation. For example, the player module 3 directly plays broadcasting a program 71 of the internet broadcasting station 7 or TV a program 91 of the internet TV station 9. The player module 3 can also, together with the processing module 2, record the broadcasting a program 71 and/or execute a program subscription setting of the internet broadcasting station 7 or the TV a program 91 of the internet TV station 9. Further, the player module 3 can also receive advertising information 61 transmitted from the advertisement broadcasting server 6 in accordance with the region where the user is located or an ID code of the player device 1.

The player module 3, together with the processing module 2, can record the broadcasting a program 71 as an audio/video file 72, and/or execute a broadcasting program subscription setting 73. Alternatively, the player module 3, together with the processing module 2, can record the TV a program 91 as an audio/video file 92, and/or execute a TV program subscription setting 93. The audio/video file 72 and the broadcasting program subscription setting 73, or the audio/video file 92 and the TV program subscription setting 93 are saved in a storage module 22 of the player device 1. The storage module 22 can be disposed inside or outside the player module 3.

The player device 1 can be an independent device, such as a cellular phone, a multimedia player, a set-top box. The player device 1 can be connected to the internet. The player device 1 further includes an independent display or an additionally provided external display. The processing module 2 can be a hardware unit (e.g., MCU, or CPU), a firmware, or a software. The player module 3 can be a hardware unit, a firmware, or a software. The storage module 22 can be any kind of memory device.

As discussed above, the present invention provides a player device. The player device is adapted for playing an internet broadcasting station or an internet TV station. The player device is connected to at least one internet broadcasting station server, and/or at least one internet TV station server, and/or at least one advertisement broadcasting server. A user utilizes the player device to select and download a station list provided by the internet broadcasting station server and/or the internet TV station server. The player device is then connected to at least one of the selected internet broadcasting stations and/or internet TV stations. The player device directly plays a program of the connected internet broadcasting station or internet TV station. The player device may further record the program of the connected internet broadcasting station or internet TV station or execute a program subscription setting. Furthermore, the player device can also receive advertising information transmitted from the advertisement broadcasting server in accordance with a region where the user is located or an ID code of the player device.

The player device has the following advantages:

1. After the user utilizes the player device to select and download the station list provided by the internet broadcasting station server and/or the internet TV station server, the player device is connected to at least one of the selected internet broadcasting stations and/or internet TV stations. In addition to directly playing the program of the program of the connected internet broadcasting station or internet TV station, the player device is further adapted for recording the program and/or executing a program subscription setting; and

2. The user can utilize the player device for receiving advertising information transmitted from the advertisement broadcasting server in accordance with a region where the user is located or an ID code of the player device.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A player device, adapted for playing an internet broadcasting station and/or an internet TV station, the player device comprising:
a processing module, adapted for executing a logging program for allowing at least one server connected to the player device to identify an identification of a user using the player device and access a setting made by the user; and
a player module, by which the user is allowed to select and download a station list provided by the at least one server, wherein after selecting and downloading the station list, the player device is connected to at least one selected internet broadcasting station and/or at least one internet TV station, for executing subsequent operation.

2. The player device according to claim 1, wherein the at least one server is at least one internet broadcasting server and/or at least internet TV station server for providing the station list.

3. The player device according to claim 2, wherein the at least one server comprises at least one advertisement broadcasting server, and the player module is adapted for receiving advertising information transmitted from the at least one advertisement broadcasting server in accordance with a region where the user is located or an ID code of the player device.

4. The player device according to claim 3, wherein the subsequent operation is directly playing a program of the at least one selected internet broadcasting station and/or at least one internet TV station.

5. The player device according to claim 3, wherein the subsequent operation is recording a program of the at least one selected internet broadcasting station and/or at least one internet TV station.

6. The player device according to claim 3, wherein the subsequent operation is executing a program subscription setting of the at least one selected internet broadcasting station and/or at least one internet TV station.

7. The player device according to claim 3, wherein the player device is a portable device.

8. The player device according to claim 3, wherein the player module is a hardware unit.

9. The player device according to claim 3, wherein the player module is a firmware.

10. The player device according to claim 3, wherein the player module is a software.

11. A player device, adapted for playing an internet broadcasting station and/or an internet TV station, the player device being is wirely or wirelessly connected to at least one internet broadcasting server, and at least one advertisement broadcasting server via a PC to configure a network connection, the player device comprising:
a processing module, adapted for executing a logging program for allowing a user to transmit related information to the at least one internet broadcasting server and the at least one advertisement broadcasting server for identifying an identification of the user and accessing a setting made by the user; and
a player module, by which the user is allowed to select and download a station list provided by the at least one internet broadcasting server, wherein after selecting and downloading the station list, the player device is connected to the selected at least one internet broadcasting station via the PC, for executing subsequent operation.

12. The player device according to claim 11, wherein the player module is adapted for receiving advertising information transmitted from the at least one advertisement broadcasting server in accordance with a region where the user is located or an ID code of the player device.

13. The player device according to claim 11, wherein the subsequent operation is directly playing a program of the at least one selected internet broadcasting station and recording the program.

14. The player device according to claim 11, wherein the subsequent operation is executing a program subscription setting of the at least one selected internet broadcasting station.

15. The player device according to claim 11, wherein the player device is a portable device.

16. A player device, adapted for playing an internet broadcasting station and/or an internet TV station, the player device being is directly and wirely or wirelessly connected to at least one internet broadcasting server, and at least one advertisement broadcasting server to configure a network connection, the player device comprising:
a processing module, adapted for executing a logging program for allowing a user to transmit related information to the at least one internet broadcasting server and the at least one advertisement broadcasting server for identifying an identification of the user and accessing a setting made by the user; and
a player module, by which the user is allowed to select and download a station list provided by the at least one internet broadcasting server, wherein after selecting and downloading the station list, the player device is directly connected to the selected at least selected internet broadcasting station, for executing subsequent operation.

17. The player device according to claim 16, wherein the player module is adapted for receiving advertising information transmitted from the at least one advertisement broadcasting server in accordance with a region where the user is located or an ID code of the player device.

18. The player device according to claim 16, wherein the subsequent operation is directly playing a program of the at least one selected internet broadcasting station and recording the program as an audio/video file, wherein the player device further comprises a storage module for saving the audio/video file.

19. The player device according to claim 16, wherein the subsequent operation is executing a program subscription setting of the selected at least one internet broadcasting station, wherein the player device further comprises a storage module for saving the program subscription setting.

20. The player device according to claim 16, wherein the player device is a portable device.
